(19) United States
(12) Patent Application Publication
(10) Pub. No.: US 2020/0210168 A1
(43) Pub. Date: Jul. 2, 2020

(54) SYSTEMS AND METHODS FOR UTILIZING ENCRYPTION IN MICROCONTROLLERS FOR FOTA

(71) Applicant: Continental Automotive Systems Inc., Auburn Hills, MI (US)

(72) Inventors: Brian Farrell, Troy, MI (US); David Bellomo, Zapopan (MX); Gerardo Rosas, Tlajomulco de Zuñiga (MX); Francisco Ruvalcaba Moya, Guadalajara (MX)

(21) Appl. No.: 16/683,382

(22) Filed: Nov. 14, 2019

Related U.S. Application Data
(60) Provisional application No. 62/785,878, filed on Dec. 28, 2018.

(51) Int. Cl. G06F 8/658; G06F 21/57; G06F 21/60; B60R 25/24; H03M 13/09

(52) U.S. Cl. CPC G06F 8/658; G06F 21/572; G06F 21/602; B60R 2325/108; B60R 25/241; H03M 13/09; B60R 25/248

(57) ABSTRACT

A firmware update system includes a microcontroller which includes an encryption module configured to perform an encryption function. An update module is configured to communicate with the microcontroller to provide a firmware update. The update module includes a decryption module configured to convert the firmware update from plaintext into decryption ciphertext using a decryption function. The encryption module is configured to convert the decryption ciphertext into plaintext such that the microcontroller can execute the plaintext to implement the firmware update.

### BACKGROUND

This disclosure relates generally to systems and methods for utilizing encryption in microcontrollers for firmware updates.

Microcontrollers, such as keyless entry and start chips for vehicles, may be used in a variety of applications, including uses in automotive systems in some examples. Automotive systems employ or connect with microcontrollers for applications such as keyless entry and keyless start. Some microcontrollers include encryption modules for securely sending commands to associated vehicles.

### SUMMARY

A firmware update system according to an exemplary embodiment of this disclosure, among other possible things, includes a microcontroller which includes an encryption module configured to perform an encryption function. An update module is configured to communicate with the microcontroller to provide a firmware update. The update module includes a decryption module which is configured to convert the firmware update from plaintext into decryption ciphertext using a decryption function. The encryption module is configured to convert the decryption ciphertext into the plaintext such that the microcontroller can execute the plaintext to implement the firmware update.

In a further example of the foregoing, the microcontroller is a keyless entry chip for a vehicle.

In a further example of any of the foregoing, the encryption module is configured to encrypt signals from the keyless entry chip to the vehicle.

In a further example of any of the foregoing, the encryption module is an AES encryption module.

A method of updating firmware of a microcontroller according to an exemplary embodiment of this disclosure, among other possible things, includes providing plaintext of a firmware update and converting the plaintext of the firmware update into a decryption ciphertext. The example method includes communicating the decryption ciphertext to a microcontroller, and using an encryption module to convert the decryption ciphertext of the firmware update back into the plaintext. The example method includes executing the plaintext to implement the firmware update on the microcontroller.

In a further example of the foregoing, the decryption cipher is an AES decryption cipher, the encryption module is an AES encryption module, and the microcontroller is a keyless entry and start chip for a vehicle.

In a further example of any of the foregoing, the microcontroller is a keyless entry chip for a vehicle.

In a further example of any of the foregoing, the encryption module is configured to encrypt signals from the keyless entry chip to the vehicle.

In a further example of any of the foregoing, the method includes performing a cyclic redundancy check on the firmware update. The step of converting the plaintext of the firmware update into a decryption ciphertext includes decrypting a check value of the cyclic redundancy check. The step of converting the decryption ciphertext of the firmware update back into the plaintext includes encrypting the decrypted check value. A second cyclic redundancy check is performed at the keyless entry chip to determine whether the firmware update has been modified.

In a further example of any of the foregoing, the decryption ciphertext is AES ciphertext.

In a further example of any of the foregoing, the step of communicating is performed through BLE or Wi-Fi.

A method of updating firmware of a keyless entry chip for a vehicle according to an exemplary embodiment of this disclosure, among other possible things, includes providing plaintext of a firmware update and converting the plaintext of the firmware update into a decryption ciphertext in an update module. The example method includes communicating the decryption ciphertext from the update module to the keyless entry chip and using an encryption module of the keyless entry chip to convert the decryption ciphertext of the firmware update back into the plaintext. The encryption module is also configured to encrypt signals from the keyless entry chip to the vehicle. The example method includes executing the plaintext to implement the firmware update on the microcontroller.

In a further example of the foregoing, the method includes performing a cyclic redundancy check on the firmware update. The step of converting the plaintext of the firmware update into a decryption ciphertext includes decrypting a check value of the cyclic redundancy check. The step of converting the decryption ciphertext of the firmware update back into the plaintext includes encrypting the decrypted check value. A second cyclic redundancy check is performed at the keyless entry chip to determine whether the firmware update has been modified.

In a further example of any of the foregoing, the decryption ciphertext is AES ciphertext.

In a further example of any of the foregoing, the step of communicating is performed through BLE or Wi-Fi.

These and other features disclosed herein can be best understood from the following specification and drawings, the following of which is a brief description.

### BRIEF DESCRIPTION OF THE DRAWINGS

FIG. 1 schematically shows an example firmware update system.

FIG. 2 shows a flowchart of an example method of updating firmware of a microcontroller.

FIG. 3 shows a flowchart of a second example method of updating firmware of a microcontroller.

### DETAILED DESCRIPTION

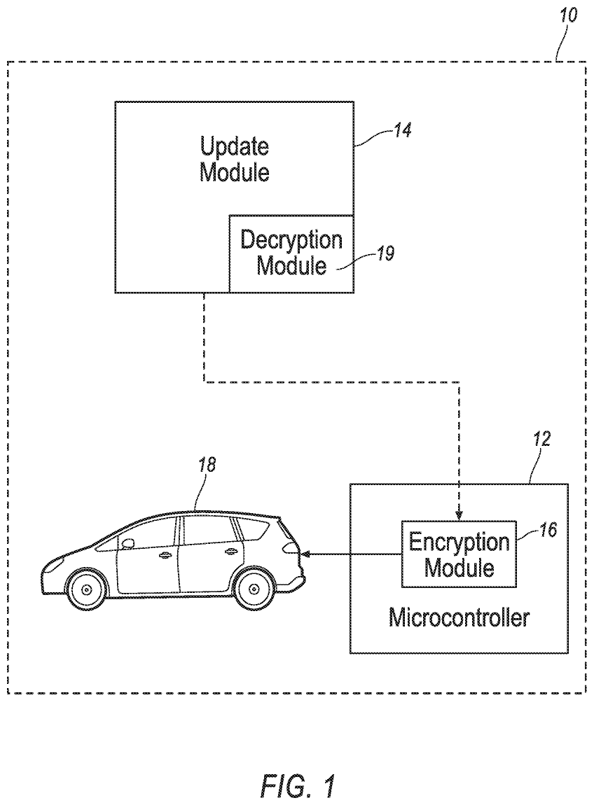

FIG. 1 schematically illustrates an example firmware update system 10 for updating the firmware of a microcontroller 12. As shown, a microcontroller 12 is in communication with an update module 14. The microcontroller 12 includes an encryption module 16, which may be an advanced encryption standard (“AES”) module 16 in some examples, as shown. AES is a known specification for the encryption of electronic data. Other encryption specifications may be utilized in some examples.

In some examples, as shown, the microcontroller 12 is a keyless entry and/or start chip for a vehicle 18, such as that provided in a vehicle fob, that provides AES encryption. In some examples, the keyless entry and start chip may not provide AES decryption or authentication capabilities and may have limited CPU resources. The keyless entry and start chip for a vehicle may, however, provide for AES encryption with the AES module 16 so that the chip can securely transmit commands, such as entry and start commands, to the vehicle 18. In some examples, the keyless entry and start chip for the vehicle 18 may transmit such commands via radio frequency transmissions.

In some examples, the update module 14 is remote from but still in communication with, the microcontroller 12. In some examples, the update module 14 includes one or more of a server, CPU, wireless connection, and/or other hardware, software, and connectivity allowing the update module 14 to provide firmware updates to the microcontroller 12. In some examples, the firmware updates are flash updates involving the overwriting of existing firmware on the microcontroller 12.

In some examples, the update module 14 may be controlled by one or more of the manufacturer, OEM, or originator of the microcontroller 12 to allow the original manufacturer of the microcontroller 12 to update the firmware of the microcontroller 12. The update module 14 communicating with the microcontroller 12 may allow the manufacturer, OEM, or originator of the microcontroller 12 to update the firmware of the microcontroller 12 in response to an event or after the microcontroller 12 is in use.

In some examples, the update module 14 stores and has access to system and identification information about the microcontroller 12. In some examples, the system and identification information includes one or more of the microcontroller 12 current firmware, associated vehicles, or location. In some examples, the update module 14 includes a decryption module 19, which performs a decryption function to provide decryption cipher. As is known, an encryption function may be performed on plaintext, which results in ciphertext. A decryption function may be performed on the ciphertext, which results in the original plaintext. In some examples, the decryption module 19 provides an AES decryption cipher. The decryption module 19 is decrypts the plaintext firmware updates into decryption cipher, which may then be sent to the microcontroller 12, as described below. The microcontroller 12, using its AES module 16, can then convert the decryption cipher back into plaintext to execute the firmware update at the microcontroller 12. With the encryption function being the inverse operation of the decryption function, the AES module 16 performs an encryption function on the decrypted ciphertext to convert the decrypted ciphertext back to plaintext. The disclosed systems and methods therefore allow for secure firmware updates to be sent to the microcontroller 12, even if the microcontroller 12 does not have a decryption module and only has an encryption module.

The update module 14 provides firmware over the air (“FOTA”) updates to the microcontroller 12. The firmware update system 10 utilizes AES, or a similar cipher, to protect and keep confidential the updated firmware being provided to the microcontroller 12. In some examples, utilizing AES or other ciphertext protects against any undesired individual discovering potential security vulnerabilities in software of the microcontroller 12.

In some examples, the integrity of the firmware may be verifiable by including a cyclic redundancy check (“CRC”) in the firmware image. That is, a check value, or checksum, is attached to the firmware update data and is based on a calculation of the remainder of a polynomial division of the data contents. In some examples, the CRC is included in the firmware image before the decryption of the firmware. In some examples, the CRC is added at the update module 14.

In some examples, the CRC is also decrypted as part of the firmware using the decryption module 19. Through the CRC, integrity of the firmware can be checked while access to the firmware by an unidentified person is prevented because the unidentified person would not be able to provide the correct CRC due to the firmware over which the CRC is calculated, and the CRC itself, being encrypted. The unidentified person would not be able to modify the decrypted firmware and get the correct CRC value. Once the microcontroller 12 receives and encrypts the decrypted firmware ciphertext with the appended CRC, it performs the CRC calculation again and compares the result against the received CRC value to determine whether there is a match (in which there would have been no modification to the firmware) or a mismatch (in which case there would have been a modification to the firmware). The update module 14 is able to provide FOTA updates by communicating secure ciphertext to the microcontroller 12, as will be explained in further detail below.

In some examples, the update module 14 provides FOTA updates to the microcontroller 12 via Bluetooth Low Energy (“BLE”) systems, Wi-Fi, or other wireless communication systems. In some examples, the microcontroller 12 is connected to a network, such as a Wi-Fi network or another type of network that allows the update module 14 to provide FOTA updates to the microcontroller 12 originating from the update module 14.

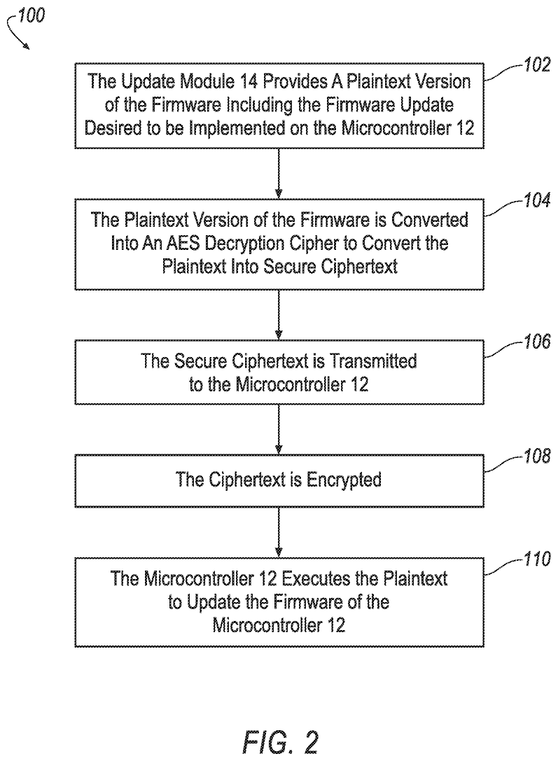

As shown in FIG. 2, with continued reference to FIG. 1, an example method of using an example firmware update system 10 of the present disclosure provides secure, authenticated FOTA updates to microcontrollers 12, such as keyless entry and start chips for a vehicle 18, as illustrated at 100.

At step 102, the update module 14 provides a plaintext version of the firmware including the firmware update desired to be implemented on the microcontroller 12.

At step 104, the plaintext version of the firmware is converted into an AES decryption cipher to convert the plaintext into secure ciphertext. In some examples, with continued reference to FIG. 1, this is done in the decryption module 19 of the update module 14 using a decryption function.

After being converted into ciphertext, at step 106, the secure ciphertext is transmitted to the microcontroller 12.

At step 108, once received by the microcontroller 12, the ciphertext is encrypted, which converts the ciphertext back to plaintext. In some examples, the ciphertext is provided to the AES encryption module 16 of the microcontroller 12, which converts the secure ciphertext back into plaintext using an encryption function.

At step 110, after converting the secure ciphertext back into plaintext, the microcontroller 12 executes the plaintext to update the firmware of the microcontroller 12.

As illustrated at 100, a microcontroller 12 firmware image can remain confidential while being updated over the air. As discussed above, authenticity of the firmware can be verified using a CRC in the firmware image.

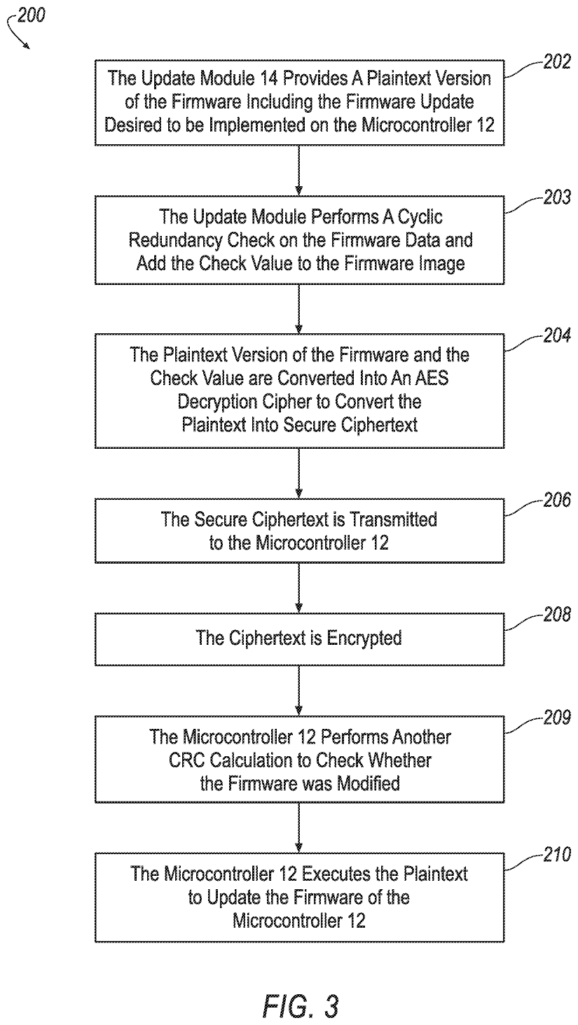

As shown in FIG. 3, with continued reference to FIG. 1, another example method of using an example firmware update system 10 of the present disclosure provides secure, authenticated FOTA updates to microcontrollers 12, such as keyless entry and start chips for a vehicle 18, as illustrated at 200 using a cyclic redundancy check (“CRC”).

At step 202, the update module 14 provides a plaintext version of the firmware including the firmware update desired to be implemented on the microcontroller 12.

At 203, the update module performs a cyclic redundancy check on the firmware data and add the check value to the firmware image.

At step 204, the plaintext version of the firmware and the check value are converted into an AES decryption cipher to convert the plaintext into secure ciphertext. In some examples, with continued reference to FIG. 1, this is done in the decryption module 19 of the update module 14 using a decryption function.

After being converted into ciphertext, at step 206, the secure ciphertext is transmitted to the microcontroller 12.

At step 208, once received by the microcontroller 12, the ciphertext is encrypted, which converts the ciphertext back to plaintext. In some examples, the ciphertext is provided to the AES encryption module 16 of the microcontroller 12, which converts the secure ciphertext back into plaintext using an encryption function.

At step 209, the microcontroller 12 performs another CRC calculation to check whether the firmware was modified, comparing the result of the calculation against the received CRC value to determine whether there is a match (in which there would have been no modification to the firmware) or a mismatch (in which case there would have been a modification to the firmware).

At step 210, after converting the secure ciphertext back into plaintext, if determined that there was no modification to the firmware, the microcontroller 12 executes the plaintext to update the firmware of the microcontroller 12.

In some disclosed examples, an encryption module implemented in keyless entry chips intended to be used for securely sending entry and start commands to the vehicle, or in other microcontrollers, is used to enable updating the firmware over-the-air while maintaining the confidentiality of the firmware. In some examples, authenticity of the firmware may be checked by including a CRC in the firmware image that is also encrypted as part of the firmware. In some examples, an attacker would be unable to provide a correct CRC since the firmware over which it is calculated would be encrypted as well as the CRC itself.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A firmware update system comprising:
a microcontroller including an encryption module configured to perform an encryption function; and
an update module configured to communicate with the microcontroller to provide a firmware update, wherein the update module includes a decryption module configured to convert the firmware update from plaintext into decryption ciphertext using a decryption function, and the encryption module is configured to convert the decryption ciphertext into plaintext such that the microcontroller can execute the plaintext to implement the firmware update.

2. The firmware update system as recited in claim 1, wherein the microcontroller is a keyless entry chip for a vehicle.

3. The firmware update as recited in claim 2, wherein the encryption module is configured to encrypt signals from the keyless entry chip to the vehicle.

4. The firmware update system of claim 3, wherein the encryption module is an AES encryption module.

5. A method of updating firmware of a microcontroller comprising:
providing plaintext of a firmware update;
converting the plaintext of the firmware update into a decryption ciphertext;
communicating the decryption ciphertext to a microcontroller;
using an encryption module to convert the decryption ciphertext of the firmware update back into the plaintext; and
executing the plaintext to implement the firmware update on the microcontroller.

6. The method as recited in claim 5, wherein the decryption cipher is an AES decryption cipher, the encryption module is an AES encryption module, and the microcontroller is a keyless entry and start chip for a vehicle.

7. The method as recited in claim 5, wherein the microcontroller is a keyless entry chip for a vehicle.

8. The method as recited in claim 7, wherein the encryption module is configured to encrypt signals from the keyless entry chip to the vehicle.

9. The method as recited in claim 5, the method comprising:
performing a cyclic redundancy check on the firmware update, wherein the step of converting the plaintext of the firmware update into a decryption ciphertext includes decrypting a check value of the cyclic redundancy check, and the step of converting the decryption ciphertext of the firmware update back into the plaintext includes encrypting the decrypted check value; and
performing a second cyclic redundancy check at the keyless entry chip to determine whether the firmware update has been modified.

10. The method as recited in claim 5, wherein the decryption ciphertext is AES ciphertext.

11. The method as recited in claim 5, wherein the step of communicating is performed through BLE or Wi-Fi.

12. A method of updating firmware of a keyless entry chip for a vehicle comprising:
providing plaintext of a firmware update;
converting the plaintext of the firmware update into a decryption ciphertext in an update module;
communicating the decryption ciphertext from the update module to the keyless entry chip;
using an encryption module of the keyless entry chip to convert the decryption ciphertext of the firmware update back into the plaintext, wherein the encryption module is also configured to encrypt signals from the keyless entry chip to the vehicle; and
executing the plaintext to implement the firmware update on the microcontroller.

13. The method as recited in claim 12, the method comprising:
performing a cyclic redundancy check on the firmware update, wherein the step of converting the plaintext of the firmware update into a decryption ciphertext includes decrypting a check value of the cyclic redundancy check, and the step of converting the decryption ciphertext of the firmware update back into the plaintext includes encrypting the decrypted check value; and
performing a second cyclic redundancy check at the keyless entry chip to determine whether the firmware update has been modified.

14. The method as recited in claim 12, wherein the decryption ciphertext is AES ciphertext.

15. The method as recited in claim 12, wherein the step of communicating is performed through BLE or Wi-Fi.
